(19) United States
(12) Patent Application Publication
(10) Pub. No.: US 2006/0097978 A1
(43) Pub. Date: May 11, 2006

(54) Field-sequential color display with feedback control

(76) Inventors: Kee Yean Ng, Penang (MY); Joon Chok Lee, Sarawak (MY); Eit Thian Yap, Penang (MY); Yew Cheong Kuan, Penang (MY); Heng Yow Cheng, Penang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/970,911

(22) Filed: Oct. 22, 2004

(51) Int. Cl. G09G 3/36

(52) U.S. Cl. 345/102; 345/207

(57) ABSTRACT

A field-sequential color light system has a light source that includes multiple color light emitting diodes (LEDs) and a spectral feedback control system that is configured to drive the color LEDs, to detect light from the color LEDs, and to adjust color-sequential drive signals in response to the light detection system. Detecting the emitted light and adjusting the color-sequential drive signals in response to the light detection allows luminance and chrominance characteristics of the emitted light from the field-sequential color light system to be maintained at desired levels as the performance of the LEDs change over time.

### BACKGROUND OF THE INVENTION

Typical color liquid crystal displays (LCDs) utilize white light from a fluorescent source or white light emitting diodes (LEDs) to provide backlight. The backlight is manipulated by liquid crystal cells, color filters, and polarized filters to produce color images.

A new type of color display involves using multiple color LEDs as the light source. The color LEDs (e.g., red, green, and blue LEDs) are driven in a color-sequential manner to produce light of the desired color. For example, red, green, and blue light is generated in a sequence that is faster than the human eye can distinguish such that the sequentially generated colors blend together to produce the desired colors. Color displays that are driven in a color-sequential manner are referred to as field-sequential color displays. An advantage of LED-based field-sequential color displays over traditional color LCDs is that the field-sequential color displays do not require the color and polarized filters, which tend to absorb a significant quantity of the backlight. Because less light is absorbed, field-sequential displays can produce high intensity light with less power consumption. On the other hand, one drawback to LED-based field-sequential color displays is that the luminance and chrominance characteristics of color LEDs tend to vary with factors such as, temperature, age, drive current, and manufacturing inconsistencies.

Therefore, what is needed is an LED-based field-sequential color display that can reliably produce light with the desired luminance and chrominance characteristics.

### SUMMARY OF THE INVENTION

A field-sequential color light system has a light source that includes multiple color LEDs and a spectral feedback control system that is configured to drive the color LEDs to produce light that is used for backlighting, to detect the light from the color LEDs, and to adjust color-sequential drive signals in response to the light detection. Detecting the emitted light and adjusting the color-sequential drive signals in response to the light detection allows luminance and chrominance characteristics of the emitted light from the field-sequential color light system to be maintained at desired levels as the performance of the LEDs change over time.

In one embodiment of the light system, the spectral feedback control system includes a color sensor configured to provide color-specific feedback signals, a controller configured to generate color-specific control signals in response to the color-specific feedback signals, and a driver configured to generate color-specific drive signals in response to the color-specific control signals.

A method for operating a field-sequential color light system in accordance with the invention involves providing drive signals to a light source that includes multiple color LEDs, detecting light that is generated in response to the drive signals, generating feedback signals in response to the detected light, and adjusting color-sequential drive signals that are provided to the light source in response to the feedback signals. In an embodiment, color-specific feedback signals are generated in response to the detected light. The color-specific feedback signals are used to adjust the color-sequential drive signals for the color LEDs on a per-color basis to maintain desired luminance and chrominance characteristics of the emitted light.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts an field-sequential color light system that includes a spectral feedback control system in accordance with the invention.

FIG. 2 is an expanded view of the driver from FIG. 1 showing color-sequential logic and drivers that are specific to the red, green, and blue LEDs.

FIG. 3A is an expanded view of the controller from FIG. 1.

FIG. 3B is an expanded view of another embodiment of the controller from FIG. 1 that uses CIE 1931 tristimulus values.

FIG. 4 depicts a light system that includes a spectral feedback control system that is used to backlight an LCD panel in accordance with the invention

FIG. 5 depicts a process flow diagram of a method for operating a light system in accordance with the invention.

Throughout the description similar reference numbers may be used to identify similar elements.

### DETAILED DESCRIPTION

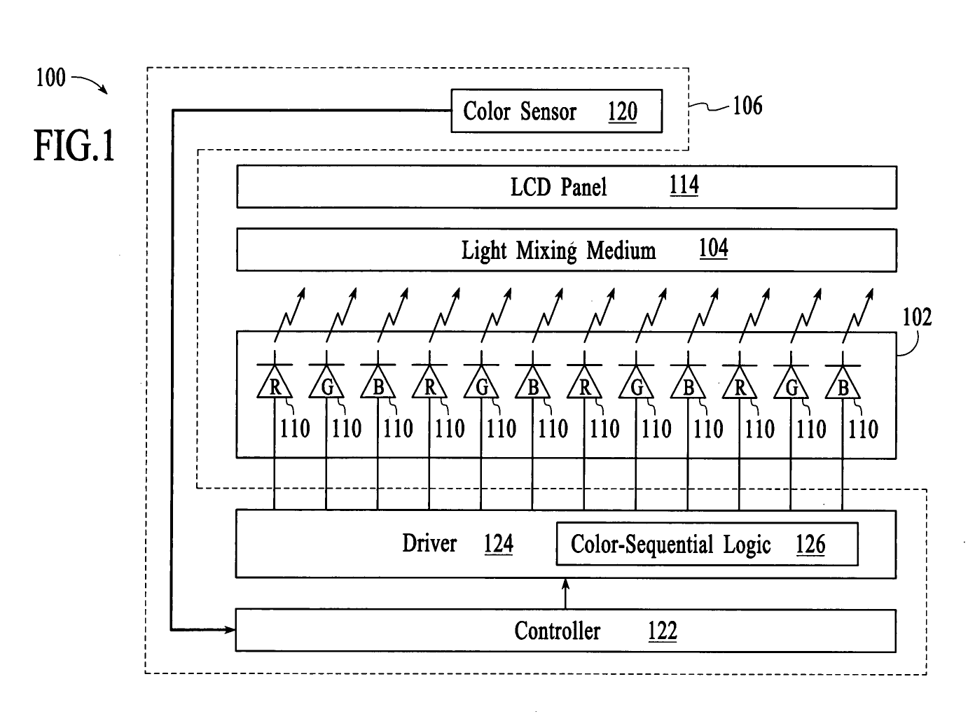

FIG. 1 depicts a field-sequential color (FSC) light system 100 that can be used, for example, as a backlight for a liquid crystal display (LCD) panel 114. The FSC light system includes a light source 102, a light mixing medium 104, and a spectral feedback control system 106.

The light source 102 is configured to generate light in response to applied drive signals. The light source is oriented with respect to the light mixing medium 104 such that light emitted from the light source passes through the light mixing medium. The light source depicted in FIG. 1 is made up of multiple light emitting diodes (LEDs) 110 that emit monochromatic light of a particular color (referred to herein as “color LEDs”). In the embodiment of FIG. 1, the color LEDs include a mix of red (R), green (G), and blue (B) LEDs that emit monochromatic colored light in the respective red, green, and blue spectrums. Color LEDs are well known in the field of LEDs. Although the color LEDs in the example embodiment of FIG. 1 are red, green, and blue, other color LED combinations can be used. For example, color mixes that include cyan and amber LEDs can be used instead of, or in addition to, red, green, and blue LEDs. The LEDs may be grouped into a matrix of pixels, with each pixel having a red, green, and blue LED. Alternatively, the LEDs may be configured into a light strip for use in edge illumination of an LCD panel. In FIG. 1, the color LEDs are distributed in a repeating pattern of red, green, and blue (RGB). Although a specific pattern of LED distribution is depicted in FIG. 1, other patterns and/or distributions of LEDs can be used. The details of the patterns and/or distributions of LEDs are specific to the application.

The light mixing medium 104 mixes the colored light that is emitted from the color LEDs 110. The light mixing medium helps to evenly distribute the different colors that are emitted from the LEDs.

The spectral feedback control system 106 includes a color sensor 120, a controller 122, and a driver 124. The color sensor is oriented with respect to the LCD panel 114, the light mixing medium 104, and the light source 102 to detect light that passes through the light mixing medium and the LCD panel after being emitted from the light source. In the embodiment of FIG. 1, the color sensor is a tri-color sensor that generates color-specific feedback signals that represent color-specific luminance and chrominance characteristics of the detected light. For example, the color sensor provides a set of electrical signals that can be used to represent tristimulus information related to the detected light.

The controller 122 controls the luminance and chrominance characteristics of the light that is generated from the light source 102. The controller uses color-specific control signals to generate light having the desired luminance and chrominance characteristics. When the light system is operated in a feedback control mode, the controller receives color-specific feedback signals from the color sensor 120 and generates color-specific control signals in response to the color-specific feedback signals.

The driver 124 translates the color-specific control signals received from the controller into color-specific drive signals that drive the light source 102 in a color-sequential manner. For example, the driver produces color-specific drive signals (e.g., red LED drive signals, green LED drive signals, and blue LED drive signals) that control the color LEDs 110 on a per-color basis. The driver includes color-sequential logic 126 that is configured to drive the LEDs in a color-sequential manner. Driving the LEDs in a color-sequential manner involves driving LEDs of the same color simultaneously one color at a time. For example, the red LEDs are driven first, the green LEDs are driven second, and the blue LEDs are driven third. Using known FSC techniques, the different color LEDs are driven at a rate that is faster than the human eye can distinguish so that the colors appear to the human eye to be blended together. For example, each group of different color LEDs is driven separately during a 60 Hz frame. In one embodiment, each of the three different groups of color LEDs (red, green, and blue) is sequentially activated during a 1/180^{th} of a second subframe during each 1/60^{th} (i.e., 60 Hz) of a second frame. By driving each group of different color LEDs separately in a color-sequential manner, light with the desired luminance and chrominance characteristics can be produced.

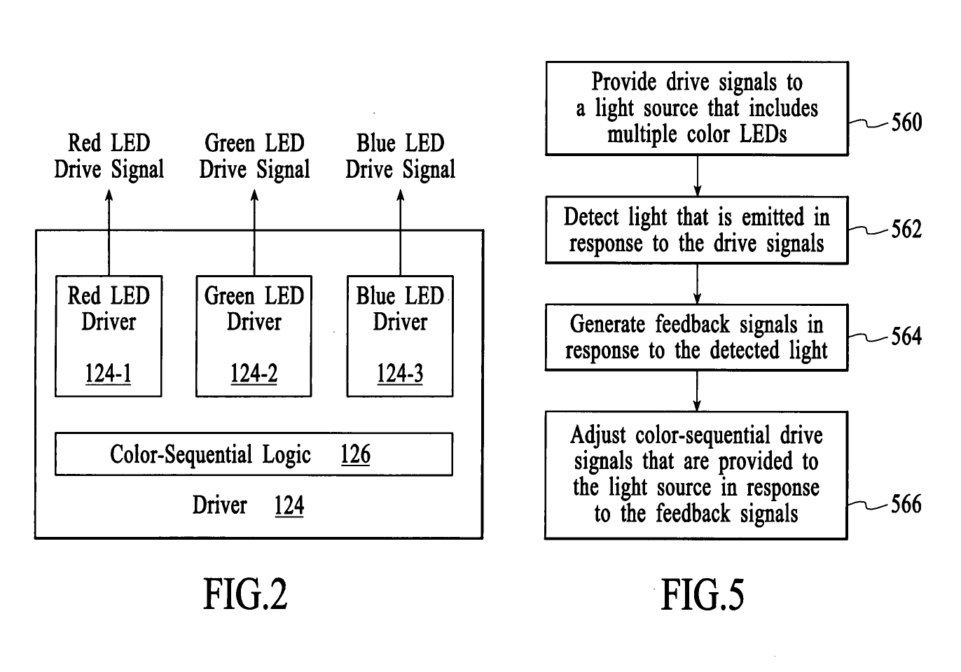

FIG. 2 depicts an expanded view of the driver 124 from FIG. 1. The driver depicted in FIG. 2 includes the color-sequential logic 126 and color-specific drivers 124-1, 124-2, and 124-3 for the red, green, and blue LEDs, respectively. The color-specific drivers produce color-specific drive signals (e.g., red LED drive signals, green LED drive signals, and blue LED drive signals), which enable the driver to control the color LEDs 110 on a per-color basis in a color-sequential manner. Time modulation (also referred to as pulse width modulation) can be used to control the intensity of the light that is emitted from the LEDs. Alternatively, the intensity of the color light can be controlled by varying the voltage and/or current of the drive signals.

During a calibration process, the spectral feedback control system 106 of FIG. 1 measures luminance and chrominance characteristics of the light that is emitted from the light source 102 and then adjusts the emitted light in response to the measurements to achieve and maintain pre-established luminance and chrominance characteristics. Operation of the calibration process is described in detail with reference to FIG. 1. Starting at the controller 122 for description purposes, the controller generates color-specific control signals to produce light having desired luminance and chrominance characteristics. The color-specific control signals are provided to the driver 124. In response to the control signals from the controller, the driver generates color-specific drive signals to drive the LEDs 110 of the light source. For example, white light that is suitable for LCD panel backlighting is produced by combining red, green, and blue light. In the calibration process, the color LEDs are driven simultaneously to produce light for backlighting. In another embodiment of the calibration process, the color LEDs are driven in a color-sequential manner to produce light for backlighting. Whether the LEDs are driven simultaneously or in a color-sequential manner during the calibration process, the driver generates color-specific drive signals that are specific to the red, green, and blue LEDs. The LEDs of the light source generate light in response to the drive signals and the light travels through the light mixing medium 104 and the LCD panel 114. The color sensor 120 detects the light that passes through the light mixing medium and the LCD panel and generates feedback signals in response to the detection. In the embodiment of FIG. 1, the color sensor outputs color-specific feedback signals related to the red, green, and blue spectrums. The color-specific feedback signals from the color sensor are received by the controller and used to adjust the control signals and ultimately the color-sequential drive signals in order to produce light with the desired luminance and chrominance characteristics. To achieve and maintain light with the desired luminance and chrominance characteristics during the normal color-sequential operation, the controller generates color-specific control signals in response to the color-specific feedback signals. In one embodiment, color-specific control signals are generated by comparing the color-specific feedback signals from the color sensor with reference color information. For example, the color-specific control signals are generated as a function of the difference between the color-specific feedback signals from the color sensor and the reference color information. Example techniques for generating color-specific control signals are described in more detail below.

The color-specific control signals that are generated by the controller 122 are provided to the driver 124. The driver translates the color-specific control signals into color-specific drive signals. The color-specific drive signals are then applied to the color LEDs 110 of the light source 102 in a color-sequential manner to produce light that is used for backlighting the LCD panel. The calibration process can be repeated until the emitted light exhibits the desired luminance and chrominance characteristics. Measuring the actual luminance and chrominance characteristics of the emitted light and adjusting the LED drive signals in response to the actual measurements allows the desired luminance and chrominance characteristics to be maintained as the light emitted by the individual color LEDs changes.

In an embodiment, the calibration process is used selectively to adjust the luminance and chrominance characteristics of the output light. For example, the calibration process may be implemented for discrete periods of time at pre-established time intervals (e.g., once an hour, day, week, month etc.) or at fixed events (e.g., upon system start-up). In one embodiment, the calibration process is performed during power up of the light system. In another embodiment, the feedback control process is implemented while the power source (e.g., the battery of a mobile device) is being charged. The frequency with which the feedback control process is performed and the length of time required to achieve the desired luminance and chrominance characteristics is a function of various factors, such as the magnitude of light drift, the level of control desired, resource consumption concerns, etc.

In embodiments where the calibration process is used selectively to adjust the luminance and chrominance characteristics of the emitted light, the feedback control process is not implemented during normal operations. Not implementing the feedback control process during normal operations can save resources (e.g., battery power and processing cycles) that are consumed by the feedback control process. Alternatively, the calibration process can be implemented on a continuous basis during normal operation (e.g., while the color LEDs are driven in a color-sequential manner) to provide a high level of control over the luminance and chrominance characteristics of the emitted light. In an embodiment of the calibration process where the RGB LEDs are activated simultaneously, the calibration process is preferably run while the LCD panel is blanked to avoid the display of any unwanted images that may negatively impact the calibration process.

For the purposes of example, the system 100 depicted in FIG. 1 is a three color (“trichromatic”) RGB based system. The colored light of a trichromatic system may be described in terms of tristimulus values, based on matching the three colors such that the colors typically cannot be perceived individually. Tristimulus values represent the intensity of three matching lights, in a given trichromatic system, required to match a desired shade. Tristimulus values can be calculated using the following equations:

$$X = k {\sum }_{λ}^{} W {\overline{x}}_{λ} {R}_{λ}$$

$$Y = k {\sum }_{λ}^{} W {\overline{y}}_{λ} {R}_{λ}$$

$$Z = k {\sum }_{λ} W {\overline{z}}_{λ} {R}_{λ}$$

$$where$$

$$W {\overline{x}}_{λ} = {P}_{λ} {x}_{λ}$$

$$W {\overline{y}}_{λ} = {P}_{λ} {y}_{λ}$$

$$W {\overline{z}}_{λ} = {P}_{λ} {z}_{λ}$$

$$k = 100 / \sum {Wy}_{λ}$$

The relative spectral power distribution, P_{λ}, is the spectral power per constant-interval wavelength throughout the spectrum relative to a fixed reference value. The CIE color matching functions, x_{λ}, y_{λ}, and z_{λ}, are the functions x(λ), y(λ), and z(λ) in the CIE 1931 standard calorimetric system or the functions x₁₀(λ), y₁₀ (λ), and z₁₀ (λ) in the CIE 1964 supplementary standard colorimetric system. The CIE 1931 standard calorimetric observer is an ideal observer whose color matching properties correspond to the CIE color matching functions between 1° and 4° fields, and the CIE 1964 standard calorimetric observer is an ideal observer whose color matching properties correspond to the CIE color matching functions for field sizes larger than 4°. The reflectance, R_{λ,} is the ratio of the radiant flux reflected in a given cone, whose apex is on the surface considered, to that reflected in the same direction by the perfect reflecting diffuser being irradiated. Radiant flux is power emitted, transferred, or received in the form of radiation. The unit of radiant flux is the watt (W). A perfect reflecting diffuser is an ideal isotropic diffuser with a reflectance (or transmittance) equal to unity. The weighting functions, Wx_{λ}, Wy_{λ}, and Wz_{λ}, are the products of relative spectral power distribution, P_{λ,} and a particular set of CIE color matching functions, x_{λ}, y_{λ}, and z_{λ}.

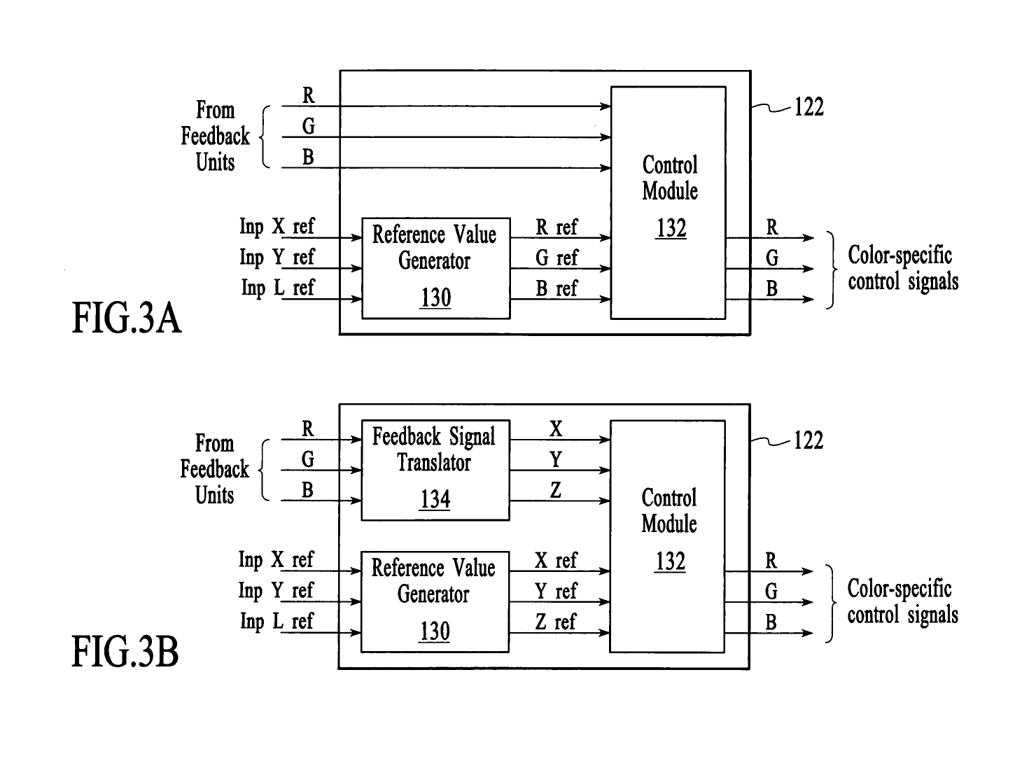

The controller 122 depicted in FIG. 1 can be implemented in many different ways to achieve color-specific control. FIGS. 3A and 3B depict examples of controllers 122 that can be used to adjust the red, green, and blue LEDs on a per-color basis in the light source depicted in FIG. 1. With reference to FIG. 3A, the controller includes a reference value generator 130 and a control module 132. The controller receives color-specific feedback signals in the form of measured tristimulus values in RGB space (R, G, and B) from the color sensor 120 (FIG. 1). The controller also receives input reference tristimulus values. The input reference tristimulus values may be in the form of a target color point (X ref and Y ref) and lumen value (L ref). The reference tristimulus values may be pre-established through a user interface (not shown), pre-programmed into the system, or the input reference tristimulus values could be received in some other manner. The reference value generator translates the input reference tristimulus values to reference tristimulus values in RGB space (R ref, G ref, and B ref). The control module then determines the difference between the measured tristimulus values and reference tristimulus values and generates color-specific control signals that reflect adjustments that need to be made to the drive signals on a per-color basis to achieve the desired luminance and chrominance characteristics. The color-specific control signals cause the color LEDs to be adjusted, as necessary, to emit light of the desired luminance and chrominance. In this way, the luminance and chrominance characteristics of the light source approach the desired (i.e., reference) luminance and chrominance characteristics.

The alternate controller of FIG. 3B is similar to the controller of FIG. 3A except that it uses CIE 1931 tristimulus values. The controller of FIG. 3B includes a feedback signal translator 134 that translates measured tristimulus values in RGB space to measured CIE 1931 tristimulus values. Additionally, the reference value generator 130 converts input reference tristimulus values to reference CIE 1931 tristimulus values. The control module 132 then determines the difference between the measured CIE 1931 tristimulus values and the reference CIE 1931 tristimulus values and adjusts the color-specific control signals accordingly.

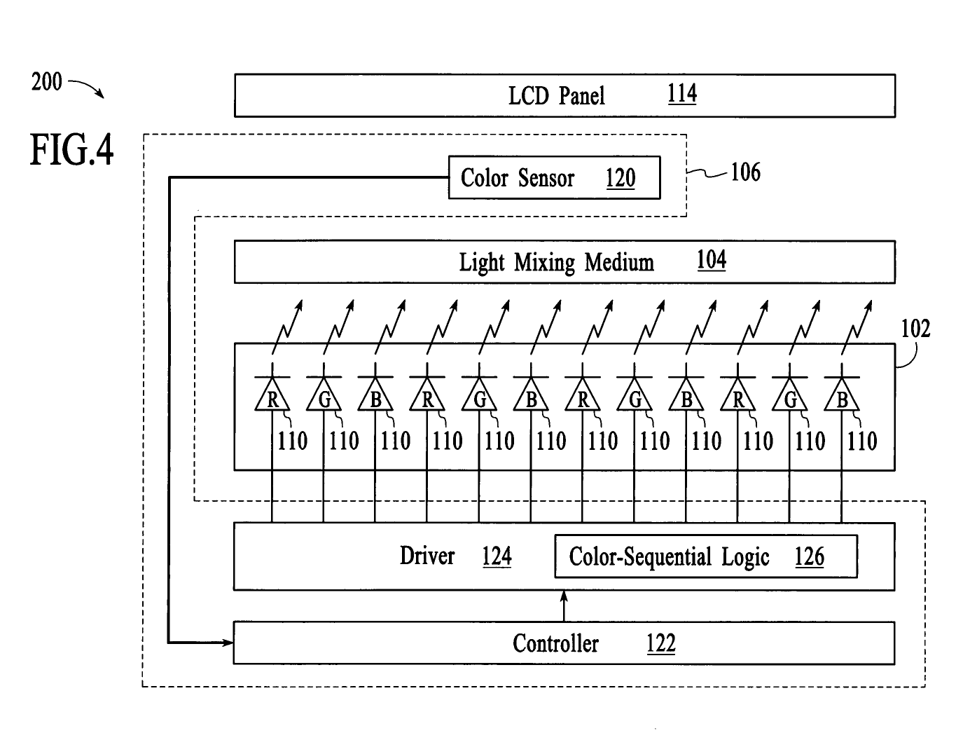

The FSC light system 100 described above with reference to FIGS. 1 3B can also be oriented such that the color sensor is configured to detect light after it is mixed but before it passes through the LCD panel 114. FIG. 4 depicts an LED-based FSC light system 200 that includes the light source 102 oriented with respect to the LCD panel 114 such that light is incident on a side surface or edge of the LCD panel as is known in the field of LCDs. For example, the color LEDs 110 are configured in a linear fashion and located along an edge of the LCD panel. When used as a backlight for an LCD panel, the light source is typically driven to produce white light. As is known in the field, white light can be produced by combining red, green, and blue light. In the embodiment of FIG. 4, during normal operation the red, green, and blue LEDs are driven in a color-sequential manner to produce white light. The desired luminance and chrominance characteristics of the white light are pre-established and the spectral feedback control system is used during the calibration process, as described above, to adjust the drive signals as necessary to achieve and maintain the desired luminance and chrominance characteristics of the emitted light.

In the embodiment of the calibration process in which the color LEDs are driven in a color-sequential manner, the color sensor can be configured to sum the individual color-specific measurements to produce a complete color measurement. For example, the color sensor will measure red light during the time that the red LEDs are driven, green light during the time that the green LEDs are driven, and blue light during the time that the blue LEDs are driven. The color-specific measurements are then summed (e.g., according to Grassman's laws) to characterize the overall luminance and chrominance characteristics of the light.

Although the color-sequential logic is disclosed as being located within the driver, color-sequential logic may be located in the controller, the driver, or any combination thereof.

FIG. 5 depicts a process flow diagram of a method for operating an FSC light system in accordance with the invention. At block 560, drive signals are provided to a light source that includes multiple color LEDs. At block 562, light that is emitted in response to the drive signals is detected. At block 564, feedback signals are generated in response to the detected light. At block 566, color-sequential drive signals that are provided to the light source are adjusted in response to the feedback signals.

Although the light systems 100 and 200 are described as a backlight for an LCD panel, the LED-based FSC light systems can be used in any other light application and are in no way limited to the above-described applications.

Other embodiments of the spectral feedback control system 106 that provide feedback signals and adjust the color LEDs on a per-color basis in response to the feedback signals are possible.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A field-sequential color (FSC) light system comprising:
a light source that includes multiple color light emitting diodes (LEDs); and
a spectral feedback control system configured to drive the color LEDs to produce light that is used for backlighting, to detect the light that is emitted from the color LEDs, and to adjust color-sequential drive signals in response to the light detection.

2. The FSC light system of claim 1 wherein the spectral feedback control system is configured to control the color LEDs on a per-color basis.

3. The FSC light system of claim 2 wherein the color LEDs include red, green, and blue LEDs.

4. The FSC light system of claim 2 wherein the spectral feedback control system further includes a color sensor configured to provide color-specific feedback signals for use in controlling the colored LEDs on a per-color basis.

5. The FSC light system of claim 4 wherein the spectral feedback control system includes a driver configured to drive multiple LEDs of the same color simultaneously.

6. The FSC light system of claim 4 wherein the spectral feedback control system includes a controller configured to control the colored LEDs on a per-color basis to maintain pre-established luminance and chrominance characteristics of the light that is output from the light source.

7. The FSC light system of claim 1 wherein the spectral feedback control system includes a color sensor configured to provide color-specific feedback signals.

8. The FSC light system of claim 7 wherein the spectral feedback control system includes a controller configured to generate color-specific control signals in response to the color-specific feedback signals.

9. The FSC light system of claim 8 wherein the spectral feedback control system includes a driver configured to generate color-specific drive signals in a color-sequential manner in response to the color-specific control signals.

10. The FSC light system of claim 1 wherein the spectral feedback control system includes:
a color sensor configured to provide color-specific feedback signals;
a controller configured to generate color-specific control signals in response to the color-specific feedback signals; and
a driver configured to generate color-specific drive signals in a color-sequential manner in response to the color-specific control signals.

11. A method for operating a field-sequential color (FSC) light system comprising:
providing drive signals to a light source that includes multiple color light emitting diodes (LEDs);
detecting light that is emitted in response to the drive signals;
generating feedback signals in response to the detected light; and
adjusting color-sequential drive signals that are provided to the light source in response to the feedback signals.

12. The method of claim 11 wherein providing drive signals includes providing drive signals simultaneously to LEDs of each color during a calibration process.

13. The method of claim 11 wherein detecting the light includes generating color-specific feedback signals.

14. The method of claim 13 wherein adjusting the drive signals includes adjusting the drive signals on a per-color basis in response to the color-specific information.

15. The method of claim 14 wherein the drive signals for the color LEDs are adjusted to maintain pre-established luminance and chrominance characteristics of the detected light.

16. A field-sequential color (FSC) light system comprising:
a light source that includes multiple red, green, and blue light emitting diodes (LEDs);
a liquid crystal display (LCD) panel in optical communication with the light source;
a light mixing medium located in an optical path between the light source and the LED panel; and
a spectral feedback control system configured to drive the color LEDs to produce light that is used to backlight the LCD panel, to detect the light from the color LEDs that is mixed in the light mixing medium, and to adjust color-sequential drive signals in response to the light detection to maintain pre-established luminance and chrominance characteristics of the light that is emitted from the light source.

17. The FSC light system of claim 16 wherein the spectral feedback control system is configured to drive the color LEDs simultaneously during a calibration process to produce the light that is used to backlight the LCD panel.

18. The FSC light system of claim 16 wherein the spectral feedback control system comprises:
a color sensor configured to provide color-specific feedback signals;
a controller configured to generate color-specific control signals in response to the color-specific feedback signals; and
a driver configured to generate color-specific drive signals in response to the color-specific control signals.

19. The FSC light system of claim 18 wherein the controller is further configured to adjust the color-specific control signals during a calibration stage to achieve the pre-established luminance and chrominance characteristics of the light that is output from the light source.

20. The FSC light system of claim 16 wherein the spectral feedback control system is configured to control the color LEDs on a per-color basis.
